(19) United States
(12) Patent Application Publication
(10) Pub. No.: US 2019/0392152 A1
(43) Pub. Date: Dec. 26, 2019

(54) DEVICE LEVEL SECURITY

(71) Applicant: MEDITECHSAFE, INC., West Chester, OH (US)

(72) Inventors: Pranav N. Patel, West Chester, OH (US); Sivakumar Kannathasan, Hamilton, OH (US)

(21) Appl. No.: 16/212,932

(22) Filed: Dec. 7, 2018

Related U.S. Application Data
(60) Provisional application No. 62/688,786, filed on Jun. 22, 2018.

(51) Int. Cl. G06F 21/57

(52) U.S. Cl. CPC G06F 21/577; G06F 3/0482; G06F 2221/034

(57) ABSTRACT

A method for implementing device level security is disclosed. The method involves detecting a device that has a security profile. The security profile has an incomplete parameter (or field) (e.g., make, model, device serial number, FDA class, protected health information, or operating system of the device). The method also includes receiving feedback from a first user to supply a data value for the incomplete parameter. The data value from the first user is validated by a second user (but can require multiple validations). The validated data value is used to identify on the device, potential attack vectors and associated vulnerabilities. The method also includes implementing a security measure based on the identified potential attack vectors and associated vulnerabilities and updating the security profile of the device accordingly.

### CROSS REFERENCE TO RELATED APPLICATIONS

This application claims the benefit of U.S. Provisional Patent Application Ser. No. 62/688,786, filed Jun. 22, 2018, entitled “DEVICE LEVEL SECURITY”, the disclosure of which is hereby incorporated by reference.

### BACKGROUND

Various aspects of the present disclosure relate generally to security measures implementable at a device level, and more particularly to the delivery of device level security measures. Yet further, aspects relate to crowd sourcing and gamification to maintain high confidence levels in device level security profiles.

The “internet of things” (IoT) generally refers to a network of physical devices such as appliances, special purpose devices, and other items that connect to, and exchange data over a network (e.g., the Internet). In this regard, an IoT device typically includes a combination of electronic circuitry, software, connectivity hardware, sensors, actuators, etc., that enable the IoT device to collect local data, and share that collected data with other devices and systems. This enhanced level of connectivity and accessibility can allow users to interact with these IoT devices remotely. However, that same level of connectivity and accessibility may also allow for third parties to access the IoT devices remotely in the form of cyber-attacks.

### BRIEF SUMMARY

According to aspects of the present disclosure, a process for implementing device level security is disclosed. The process comprises detecting a device that has a security profile. The security profile has an incomplete parameter (or data field) (e.g., make, model, device serial number, FDA class, protected health information, or operating system of the device). The process also includes receiving feedback from a first user to supply a data value for the incomplete parameter. The data value from the first user is validated by a second user (but can require multiple validations). The validated data value is used to identify on the device, potential attack vectors and associated vulnerabilities. The process also includes implementing a security measure based on the identified potential attack vectors and associated vulnerabilities and updating the security profile of the device accordingly.

According to aspects of the present disclosure a system for implementing device level security is disclosed. The system has a platform having a processor coupled to memory, wherein the platform supports interaction with devices. The processor executes program code stored in the memory to detect a device having a security profile, wherein the security profile has an incomplete parameter (or data field). The processor is also programmed to receive feedback from a first user of the platform to supply a data value for the incomplete parameter, and validate, by a second user, the data value from the first user. Moreover, the processor is programmed to identify on the device, potential attack vectors and associated vulnerabilities, based on the validated data value. Yet further, the processor is programmed to implement a security measure based on the identified potential attack vectors and associated vulnerabilities. Also, the processor is programmed to update the security profile of the device.

According to further aspects of the present disclosure, a process for user-based validation of data accuracy is disclosed. The process includes accessing a data source, the data source having a collection of security profiles. In this regard, each security profile has a confidence rating assigned thereto, which characterizes a confidence in at least one of the completeness and accuracy of the data stored in the security profile (e.g., completeness of the data stored in the security profile and/or accuracy of the data stored in the security profile). Further, the process involves selecting a parameter from the security profile based upon the confidence rating of the selected security profile (e.g., by process, or by input by a user). The process also includes transmitting to a first processing unit operated by a first user, a first question for feedback, where the first question is generated based upon the selected parameter. The process further includes receiving the first feedback from the first processing unit operated by the first user. Moreover, the process involves transmitting to a second processing unit operated by a second user, a second question for feedback, where the second question is generated based upon the selected parameter. Further the process includes receiving the second feedback from the second processing unit operated by the second user.

In addition, the process includes comparing the first feedback to the second feedback. Moreover, the process involves modifying the selected parameter, where there is agreement between the first feedback and the second feedback, with a parameter derived from the first feedback and the second feedback. Also, the process includes computing an updated confidence rating based upon the first feedback and the second feedback. Further, the process includes rewarding the first user and/or the second user based on the compared feedback.

### BRIEF DESCRIPTION OF THE SEVERAL VIEWS OF THE DRAWINGS

FIG. 1 illustrates an example of a network with medical devices in a hospital setting, according to various aspects of the present disclosure;

FIG. 2 illustrates an example medical device cyberinfrastructure, according to various aspects of the present disclosure;

FIG. 3 illustrates a process for implementing device level security, according to various aspects of the present disclosure;

FIG. 4A illustrates a table showing parameters, vulnerabilities, and attack vectors, according to various aspects of the present disclosure;

FIG. 4B illustrates a continuation of the table of parameters and corresponding attack vectors of FIG. 4A, according to various aspects of the present disclosure;

FIG. 5 illustrates a chart for game-based application parameters, according to various aspects of the present disclosure;

FIG. 6 illustrates a medical device, according to various aspects of the present disclosure;

FIG. 7 illustrates a table of attack vectors that corresponds to the medical device of FIG. 6, according to various aspects of the present disclosure;

FIG. 8 illustrates an example of a security profile, according to various aspects of the present disclosure;

FIG. 9 illustrates a system for implementing device level security, according to various aspects of the present disclosure;

FIG. 10 illustrates a process for user-based validation of data accuracy, according to various aspects of the present disclosure;

FIG. 11A-11E is an example user experience during various processes and systems, according to various aspects of the present disclosure; and

FIG. 12 is a flow chart for questions and answers for users, according to various aspects of the present disclosure.

### DETAILED DESCRIPTION

Various aspects of the present disclosure are generally directed toward improving the implementation of security measures, particularly at a device level. In addition, further aspects of the present disclosure are generally directed to incentive-based crowdsourcing to provide data integrity as a basis for device level security measures.

From a practical standpoint, nearly every entity including corporations, associations, small businesses, independent contractors, and every day individuals are data driven. Generally, the more technologically driven an entity is, the more that entity relies on reliability and integrity of data, especially in the context of security.

Entities, including corporations and associations can be the target of a variety of different forms of attack, including cyber-attacks. Notably, the effect of cyber-attacks can become more pronounced when the target entity houses sensitive data such as financial records or health records. Moreover, the introduction of devices that connect to the Internet via a network, i.e., internet of things (IoT) devices, can further complicate security concerns.

For clarity of discussion and for convenience of illustration, specific examples herein are presented in the context of the medical industry (e.g., hospitals and other healthcare organizations). However, the present disclosure can be applied to numerous entities in different industries (e.g., any entity that utilizes networked devices).

For instance, hospitals may have a security concern in the form of operations technology (OT), which include patient facing devices such as electrocardiogram devices, medication dispensers, operating room devices, and more. As more devices are added to a network with internet access (IoT), the number of attack vectors (i.e., pathways by which a cyber-attack can be carried out) increases.

Further, while many medical devices are connectable to a network, those medical devices are not always connected. Furthermore, many of the medical devices are mobile, which means that they can get connected on different networks/subnetworks at different times. Scanning operations also do not always detect all devices due to configuration design of the device(s) or network(s). Hence, it is very likely that a network scan would miss some of the devices, which may cause such devices to become vulnerable.

Moreover, devices may require regular updates or maintenance in order to run efficiently and reliably. However, the sheer number of devices can make a seemingly simple task (e.g., update and maintain) become overwhelming. Depending on the device, failure to update and maintain can range from virtually no risk to appreciable risk.

In this regard, aspects herein address and solve the technical problem of device level security by enabling cybersecurity of IoT devices (e.g., medical devices in healthcare), as these devices increasingly get connected under the IoT trend. A platform, disclosed more fully herein, facilitates device level security profiling, and tracks device level security postures (hereinafter “security profiles”), including hardware and software features, over the life cycle of each monitored device in a given environment.

According to certain aspects herein, the tracking of medical device level security profiles can be implemented as an initial step in understanding the cyber-risk(s) to/from a connected medical device. The particular knowledge of risk(s) and root cause(s) are utilized to build effective cybersecurity measures. Using the platform, a user will know what devices are possessed by the associated entity, and the respective security profiles of each device at any point in time.

In certain implementations, the platform delivers device level security profiles by uniquely combining a cloud computing architecture, workflow automation, data analytics, and crowd-sourced intelligence. In this implementation, the platform develops, validates and evolves device specific security profiles and vulnerability knowledge by electronically coordinating social efforts through a cycle of knowledge research, harvesting, organization, augmentation and calibration. In this regard, the platform in certain embodiments, uses a trigger-based automated workflow engine to ensure completeness of the necessary knowledgebase and its vitality. Moreover, the platform can utilize mobile interfaces for knowledge elicitation, coordination, augmentation and calibration.

Further, aspects of the present disclosure are directed toward user-based validation of data accuracy and integrity. By implementing incentive based crowdsourcing (also called “gamification” in some contexts) as described herein, data across nearly any industry can be gathered, updated, and validated in a manner that is far more efficient and accurate than tradition data gathering and integrity solutions, which allows for better overall device level security.

System Overview

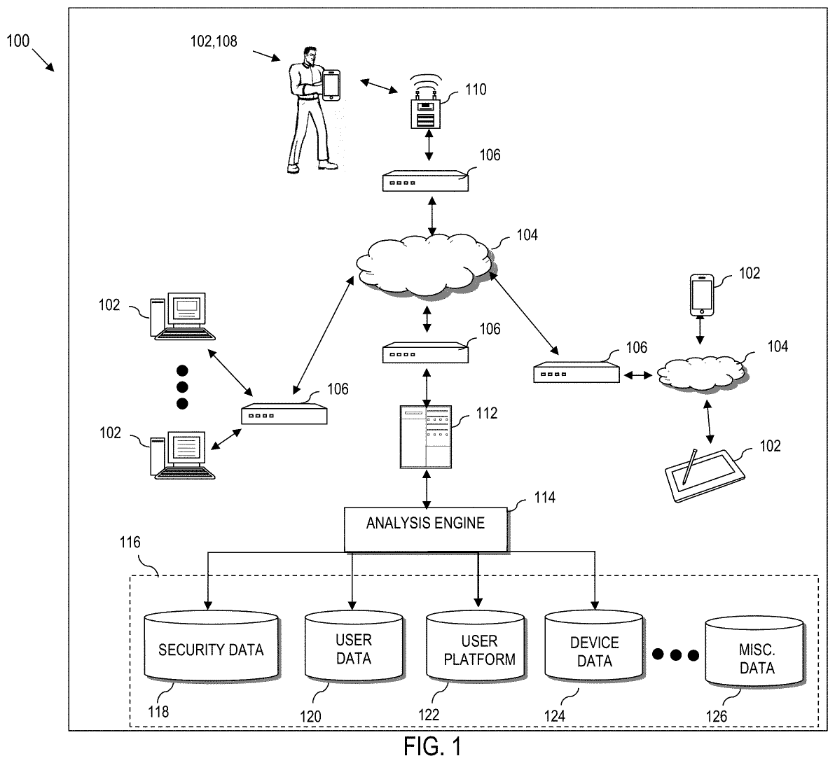

Referring now to the drawings and in particular to FIG. 1A, a general diagram of a system 100 is illustrated according to various aspects of the present disclosure. The illustrated system 100 is a special purpose (particular) computing environment that includes a plurality of hardware processing units (designated generally by the reference 102) that are linked together by one or more network(s) (designated generally by the reference 104).

The network(s) 104 provides communications links between the various processing units 102 and may be supported by networking components 106 that interconnect the processing units 102, including for example, routers, hubs, firewalls, network interfaces, wired or wireless communications links and corresponding interconnections, cellular stations and corresponding cellular conversion technologies (e.g., to convert between cellular and TCP/IP, etc.). Moreover, the network(s) 104 may comprise connections using one or more intranets, extranets, local area networks (LAN), wide area networks (WAN), wireless networks (WiFi), the Internet, including the world wide web, cellular and/or other arrangements for enabling communication between the processing units 102, in either real time or otherwise (e.g., via time shifting, batch processing, etc.).

A processing unit 102 can be implemented as a server, personal computer, laptop computer, netbook computer, purpose-driven appliance, special purpose computing device and/or other device capable of communicating over the network 104. Other types of processing units 102 include for example, personal data assistant (PDA) processors, palm computers, cellular devices including cellular mobile telephones and smart telephones, tablet computers, an electronic control unit (ECU), a display of the industrial vehicle, a multi-mode industrial management badge, etc.

Still further, a processing unit 102 can be used by one or more users 108 (noting that the user is not a component of the network itself. In the example configuration illustrated, the various components herein can wirelessly communicate through one or more access points 110 to a corresponding networking component 106, which serves as a connection to the network(s) 104. Alternatively, the users 108 operating processing units 102 equipped with WiFi, cellular or other suitable technology allows the processing unit 102 to communicate directly with a remote device (e.g., over the network(s) 104).

The illustrative system 100 also includes a processing unit implemented as a server 112 (e.g., a web server, file server, and/or other processing unit) that supports an analysis engine 114 and corresponding data sources (collectively identified as data sources 116).

In an exemplary implementation, the data sources 116 include a collection of databases that store various types of information related to an operation (e.g., a warehouse, distribution center, retail store, manufacturer, hospitals, data farms, cloud service stations, etc.). As described in greater detail herein, data can be embodied as a data set that is entirely within a digital structure such as a traditional hardware database, binary large object (BLOB) storage, remote (“cloud”) storage, representational state transfer (REST) storage, etcetera. Alternatively, or even simultaneously, data can be associated with (or embodied within) a physical device such as data reflecting hardware specifications (number of USB ports, operating system version, etc.), for example. However, these data sources 116 need not be co-located.

In the illustrative examples, the data sources 116 include databases that tie processes executing for the benefit of the enterprise, from multiple, different domains. In the illustrated example, data sources 116 include security databases 118 (e.g., housing security profile information, information regarding security vulnerabilities, patches and fixes for security vulnerabilities, etc.), a user data system 120 (e.g., for user specific data such as user types, user roles, etc. as disclosed in greater detail herein), a user platform storage 122 (e.g., housing information, programs, etc. for a user platform for use by users 108 in the various embodiments herein), a device data storage 124 (e.g., housing data on medical devices, including data on specific unique devices, etc.), and a miscellaneous data storage 126 (e.g., storage specific to industry, programs and platforms that interact with other databases and systems, programs, modules, etc.). The above list is not exhaustive and is intended to be illustrative only.

In example embodiments herein, and consistent with the United States Food and Drug Administration, a medical device is “an instrument, apparatus, implement, machine, contrivance, implant, in vitro reagent, or other similar or related article, including a component part, or accessory which is: recognized in the official National Formulary, or the United States Pharmacopoeia, or any supplement to them, intended for use in the diagnosis of disease or other conditions, or in the cure, mitigation, treatment, or prevention of disease, in human or other animals, or is intended to affect the structure or any function of the body of human or other animals (and which does not achieve any of its primary intended purposes through chemical action within or on the body of human or other animals and which is not dependent upon being metabolized for the achievement of any of its primary intended purposes). In addition, relevant medical devices can have one or more of an operating system, anti-virus, anti-malware, anti-ransomware, firmware, drivers, software platforms and other software requiring updates.

Cyberinfrastructure

Healthcare providers (e.g., hospitals, ambulatory surgery centers, imaging centers, etc.) are struggling to manage increasing level of cybersecurity risk. For instance, healthcare providers may be forced to extend great effort managing data breaches from cyberattacks on their information technology (IT) systems. However, with increasing connectivity under the IoT trend in healthcare, clinical IT networks and medical devices are becoming more exposed to cyber-attacks, such as WannaCry attacks and attacks from the OrangeWorm Group.

Cyberattacks on medical devices (Operations Technology—OT) also pose significant patient safety concerns in addition to patient data security fears.

Managing medical device centric cybersecurity risk is complex. For instance, managing medical device centric cybersecurity risk requires domain expertise not only in IT and cybersecurity but also in operations of the medical devices and clinical workflows. By way of nonlimiting example, the number, diversity in types of devices, manufacturers, configurations over life cycle, etc., how many people can access the devices, and diversity in operational processes make the medical device environment complex. In this regard, human error can contribute to cyber breaches.

However, aspects herein solve the technical problem of device security by providing a device cyberinfrastructure.

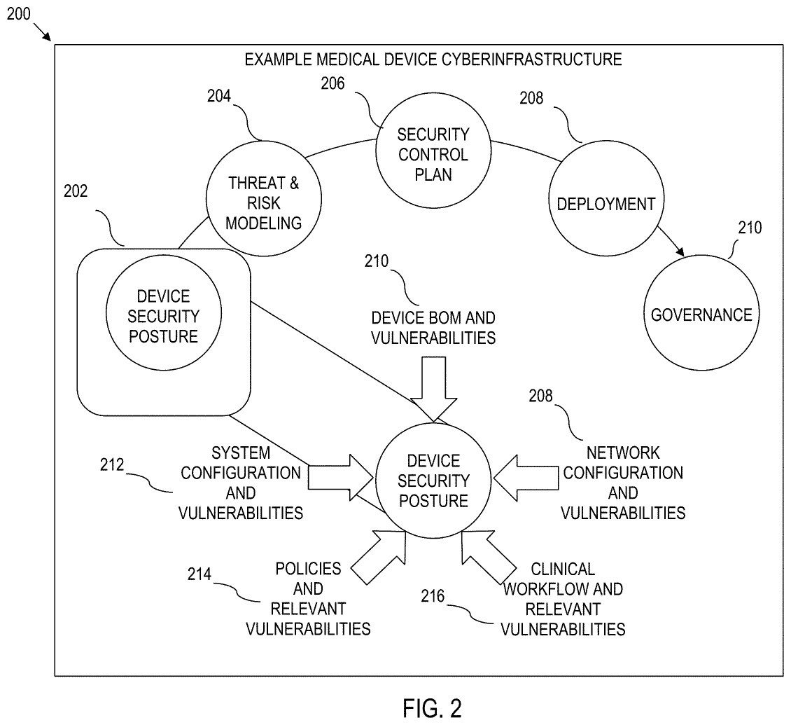

For instance, referring to FIG. 2, an example platform is implemented as a medical device cyberinfrastructure 200.

As illustrated, the cyberinfrastructure 200 includes a component that carries out device level security profiling to generate device security profiles at 202. A dynamic environment such as presented in healthcare organizations requires cybersecurity measures to be taken at the device level. In some embodiments, cybersecurity at the device level includes a comprehensive understanding of each device's security profile, which includes basic product level information such as hardware, software, operating system (OS) type, version, registry, application version, etc. Cybersecurity at the device level can also include environment centric information such as clinical use cases and workflows with user access information, key policy parameters, associated network information, and researched/published security vulnerabilities.

For instance, as illustrated, a device security profile can take into account device bill of material and vulnerabilities; network configuration and vulnerabilities; clinical workflows and relevant vulnerabilities; policies and relevant vulnerabilities; system configurations and vulnerabilities, etc. As will be described in greater detail herein, in some embodiments, the platform builds and manages device level cybersecurity profiles of all installed medical devices over their life cycles using crowd intelligence, gamification, data science and computer science.

Moreover, the platform performs collecting, validating, coordinating, augmenting, organizing, storing of device level information, or a combination thereof. For instance, device level information can be obtained from a product level, an environmental level, a device level vulnerability, and an environmental level vulnerability/loophole.

The cyberinfrastructure 200 also includes a threat and risk modeling component 204, an example of which is the threat modeling/monitoring component 220 described in application Ser. No. 15/897,535, the entirety of which is hereby incorporated by reference.

The cyberinfrastructure 200 further includes a security control plan component 206 that drives the workflows for implementing cybersecurity. An example is described by the workflow component 214 as described in application Ser. No. 15/897,535.

The cyberinfrastructure 200 yet further includes a deployment component 208. The deployment component 208 controls the deployment of security patching. An example is described by the verification and validation testing and test plans as described in application Ser. No. 15/897,535.

The cyberinfrastructure 200 moreover includes a governance component 210. An example is the governance and traceability at 416 of the verification and validation (V&V) testing as described in application Ser. No. 15/897,535.

Considerations relating to device level security profiles include, system configuration and vulnerabilities 212, policies and relevant vulnerabilities 214, clinical workflow and relevant vulnerabilities 216, network configuration and vulnerabilities 218, and device BOM (bill of materials) and vulnerabilities 210.

Aspects herein identify critical parameters, e.g., from product level information, asset level information, or both, that have the most impact on medical device cybersecurity. Aspects also include social and behavioral trigger points (e.g., fun, intellectual challenge, social purpose, incentives, etc.) that engage crowd (e.g., general public and employees) in actively researching, contributing and validating information to the platform. The gamification process utilizes these trigger points to ensure sustained engagement over the life-cycle. For instance, in some embodiments, the gamification process uses data science techniques coupled with behavioral trigger points and mobile interfaces to coordinate, augment and organize data captured from multiple sources to maintain high confidence level of the device level security profile.

More particularly, according to aspects herein, the platform engages individuals via gamification to solicitate and validate the necessary information. The information gathered here may come from an individual's knowledge or by prompting quick research through gamification. The detailed knowledge of device level security profile combined with appropriate security compensating control mechanisms is thus used to drive cybersecurity via specific automated workflows.

Moreover, aspects herein use a cloud computing architecture and trigger-based automated workflow engine to ensure completeness of the device level security profile and its vitality.

Device Level Security Measure Process

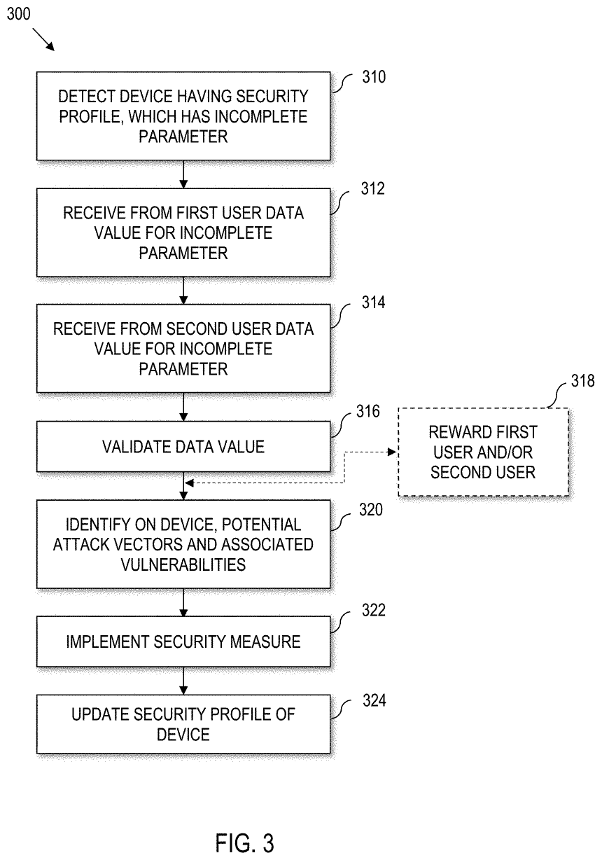

Now referring to FIG. 3, a process 300 for implementing device level security is disclosed. The process comprises detecting at 310 a device having security profile, wherein the security profile may have an incomplete parameter. The modality for detecting the device can vary based on need. By way of non-limiting example, a processing device such as a smartphone with a graphical user interface (e.g., processing device reference number 102 in FIG. 1) can be used to detect the device. Detecting the device may be accomplished by receiving a signal from the device based on proximity (e.g., radio frequency identification (RFID), Bluetooth, Ultrawide Band (UWB), etc.), or other suitable communication technique. In another example, if the device is linked to a local network, the device could be detected from that local network. As yet another example, detection can be accomplished based upon identifying an eligible user that is logged into a user platform, by identifying that the device is present in proximity to the user, a combination thereof, etc. Thus, geolocation can be used to correlate users to devices.

For this disclosure, parameters generally refer to attributes, traits, or values that are associated with the device. Examples of parameters for a given device include, but are not limited to, make, model, device serial number, FDA (food and drug administration) class, protected health information, operating system, firmware, open ports, and external connectivity of the device. Generally, parameters can be discriminated, or delineated between product level information and/or asset level information.

Product level information comprises general information that is consistent across an industry or a particular model/version of a product. Other examples of product level information include a type of device description, manufacturer, hardware specifications (e.g., processor type, amount of RAM (random access memory), etc.), a number of access ports, networking capabilities, ability to store data (e.g., personal health information), encryption capability, etc. (i.e., information that is universal across multiple unique devices sharing the same model number). Moreover, product level information can be obtained from web-scraping a data source.

Asset level information comprises information that is generally specific to a given item/device within particular group or model number. Asset level information can include serial number, a manufactured date for the device, whether or not the device is connected to a network (and how it is connected, wired, wireless, etc.), whether or not the pump is currently powered on or off, whether or not there are exposed universal serial bus (USB) ports, software version that is currently installed, etc.

For clarity, it is possible that information or data can be categorized as both product level and asset level information. Moreover, expansion or changes of capabilities of a given item/device may affect both product and asset level information. For example, supported operating systems on a scanning machine may be initially restricted to “operating system A” or “operating system B”, which could be categorized as product level information. Simultaneously, at the asset level, the scanning machine may be running operating system B. This example is by way of illustration and is in no way limiting.

In various embodiments, environmental level parameters may be considered as well. Environmental level parameters include but are not limited to critical cybersecurity relevant information based on the device such as configuration/life-cycle (e.g., features, upgrades, etc.), system configuration (e.g., Number of work-stations, redundancy, etc.), network design (e.g., flat, VLAN (virtual local area network), etc.), clinical workflow (e.g., user access, credentials, etc.) and policies that the particular device is part of.

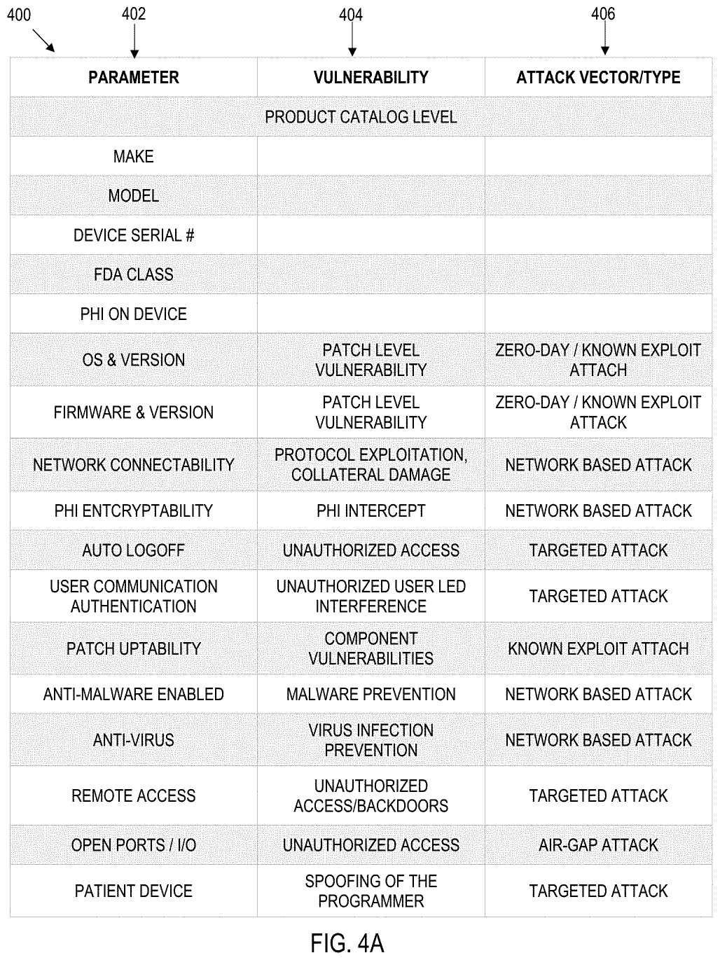

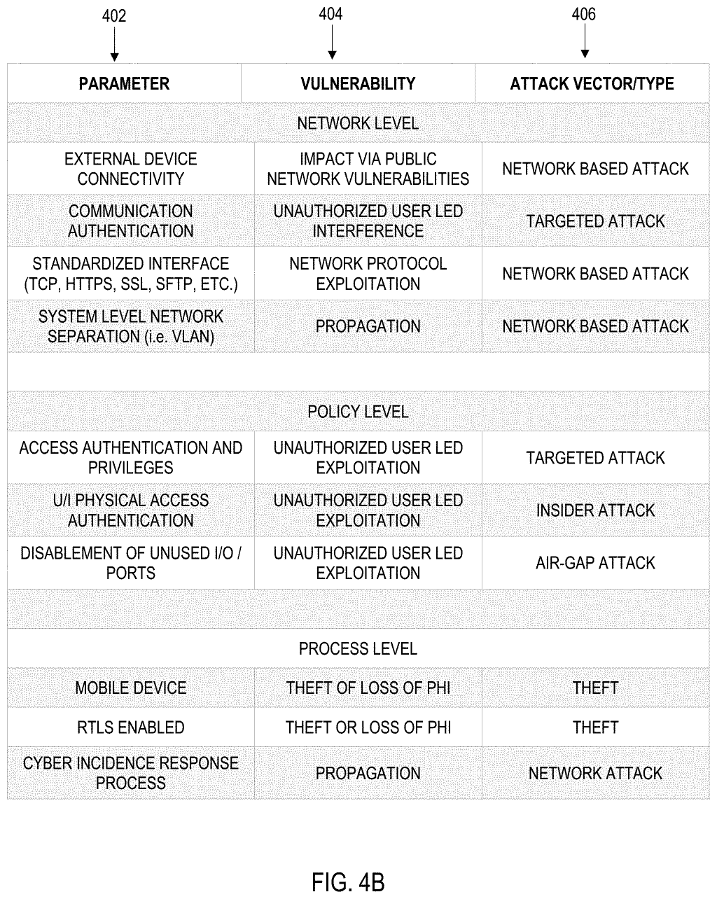

In this regard, FIG. 4A and FIG. 4B show a table 400 that comprises various parameters 402 associated with a device profile (or security profile), any one or more of which may be incomplete. Further, the table 400 comprises vulnerabilities 404 and attack vector/types 406 associated with the parameter. The parameters, vulnerabilities, and attack vectors/types in the table 400 are separated by category (e.g., product level, asset level—FIG. 4A; Network Level, Policy Level, and Process Level—FIG. 4B). The table 400 is for illustrative purpose only and is by no means limiting.

Referring back to FIG. 3, the process 300 also comprises receiving at 312 feedback from a first user to supply a data value for the incomplete parameter. There first user may come from a variety of groups of individuals such as students (e.g., medical), hospital employees (e.g., doctors, nurses, techs, etc.), or even consumers/patients. The feedback can be submitted using a variety of modalities, such as the smartphone mentioned above. Feedback can be submitted to a local network at the hospital, submitted to a cloud-based infrastructure, or via a user platform as illustrated in FIG. 1.

The process 300 further comprises receiving at 314 receiving feedback from a second user to supply a data value for the incomplete parameter. In several embodiments, the first user and the second user do not know of each other.

Further, the process 300 comprises validating at 316 the received feedback from the first user by comparing the received feedback from the first user with the received feedback from the second user. Validation at 316 can be accomplished, in certain embodiments, in a manner similar to the way the first user supplies data values for the incomplete parameter.

In various embodiments, the process 300 further comprises rewarding at 318 the first user for the feedback relating to the device, and the second user for validating the feedback from the first user (e.g., via an interactive score-based user platform).

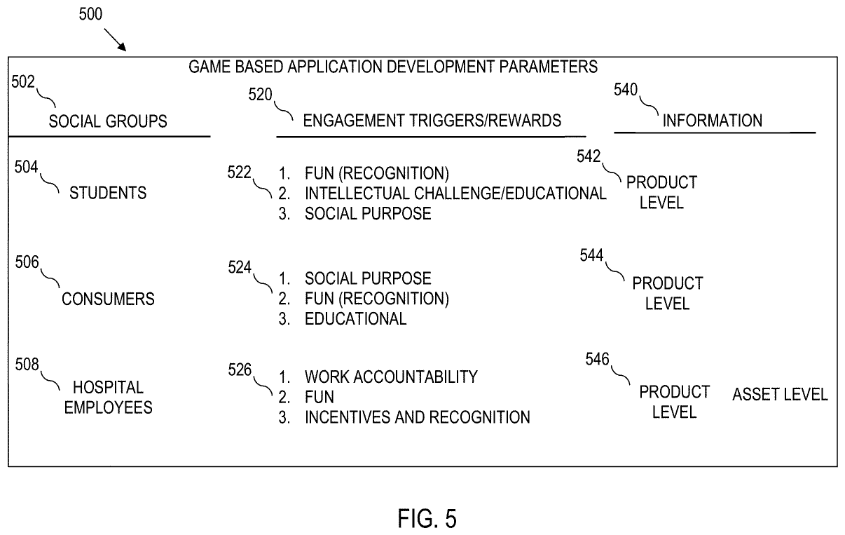

In certain embodiments, the interactive score-based user interface is implemented as a crowdsourcing application. One example of a reward structure is illustrated in FIG. 5. The structure 500 categorizes users into “social groups” 502 (i.e., a user role) such as students 504, consumers 506, and hospital employees 508. Each social group has its own engagement trigger and associated rewards 520 (e.g., students at 522, consumers at 524, and hospital employees at 526). For example, hospital employees that contribute data values for incomplete parameters and validate data values may earn incentives and recognition. Meanwhile, consumers and students be rewarded educationally. Further, each social group may be limited to or restricted to product level and/or asset level information 540 (e.g., students at 542, consumers at 544, and hospital employees at 546). This structure 500 is merely by way of example, is by no means limiting. Users, social groups, and incentive-based crowdsourcing (i.e., gamification) are disclosed in further detail herein.

Referring back to FIG. 3, the process 300 comprises identifying at 320, for the device, potential attack vectors and associated vulnerabilities, based on the validated data value(s). The potential attack vectors and associated vulnerabilities may vary from device to device.

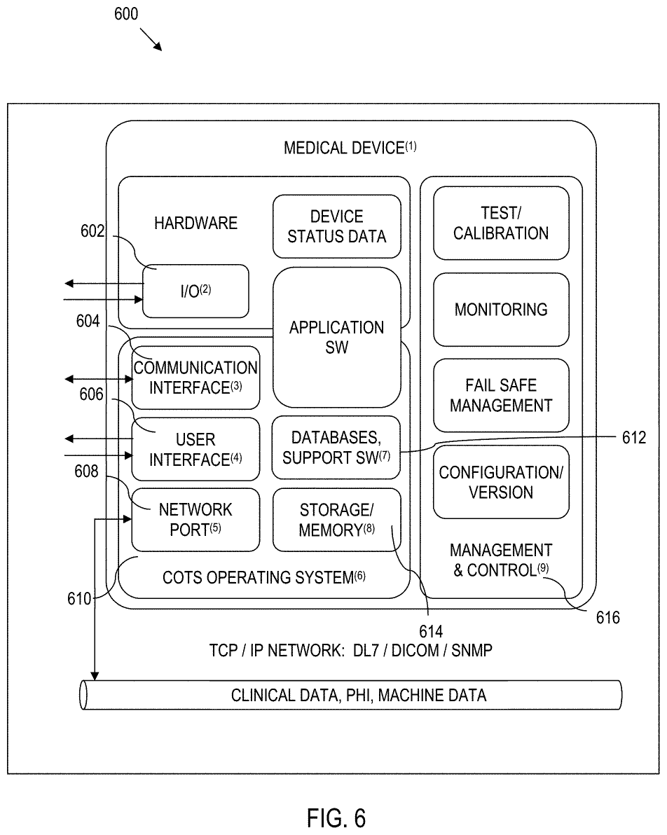

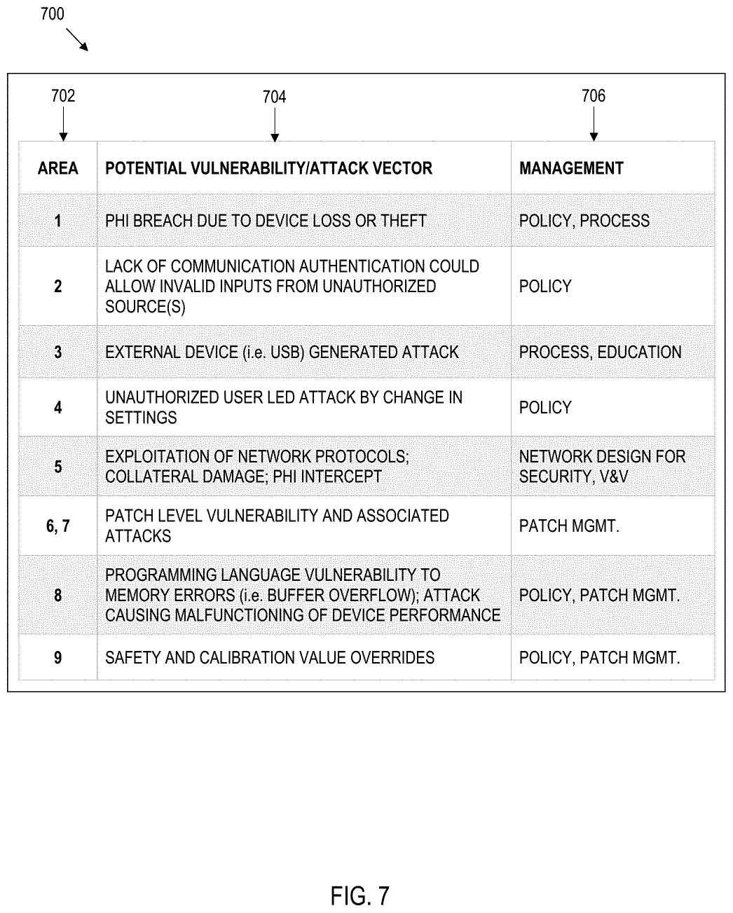

For illustrative purposes, an example medical device 600 is shown in FIG. 6. The medical device 600 has various components such as input/output (I/O) ports 602, communication interfaces 604, user interfaces, 606, network ports 608, operating systems 610, database support software 612, storage/memory 614, and management/control functions 616. Each of these components can be an attack vector for a cyber-attack. FIG. 6 also illustrates example “areas” (shown in parentheses (_)) that correspond to FIG. 7 below.

FIG. 7 illustrates a table 700 of attack vectors that corresponds to the medical device of FIG. 6. Table 700 provides sections for area 702, potential vulnerabilities 704, and management 706 (e.g., remediation for the vulnerabilities). For example, “area 4”, which has a potential vulnerability by “UNAUTHORIZED USER LED ATTACK BY CHANGE IN SETTINGS” in FIG. 7 corresponds to user interface 606 in FIG. 6.

Table 700 is just one example of many potential possibilities, and the management solutions are by no means limiting.

Thus, with the information from above, a likelihood of cyber-attack can be generated based on the security profile and the potential attack vectors. For example, for a CT machine (e.g., X-ray), may have a score of 5/10 of having network-based attack, 3/10 of theft, and 6/10 of zero-day or known vulnerability attack based on the security profiles and attack vectors. More in-depth methods of quantifying security within security profiles (known as a “risk rating”) is described in greater detail below.

Referring back to FIG. 3, the process 300 comprises implementing at 320 a security measure based on the identified potential attack vectors and associated vulnerabilities. In various embodiments, implementing a security measure comprises obtaining a security measure that corresponds to the associated vulnerabilities, and installing the security measure on the device. Obtaining a security measure may be accomplished by web-scraping various data sources that relate to vulnerabilities and security measures (e.g., websites, security apps and services, manufacture released validated patches, etc.). Additional information relating to security measures and mitigative action data can be found in application Ser. No. 15/897,535, the entirety of which is incorporated by reference above.

Further, the process 300 comprises updating at 320 the security profile of the device. In various embodiments, updating 320 the security profile of the device comprises uploading the updated security profile to a cloud computing architecture, or the user platform. The cloud computing architecture is linked to, and can be accessed by, the healthcare organization.

### Practical Example

A clinician enters a recovery room in a hospital. Within the recovery room is a heart rate monitor that is currently not in use. An alert goes off on the clinician's mobile device based on proximity to the heart rate monitor. The clinician takes notes of the model number and firmware version data values of the heart rate monitor, which he submits to the designated destination via the mobile device. For example, submission of the data values can be accomplished by filling out a template form with parameter to fill in.

Later that afternoon, a nurse enters the recovery room and receives an alert on her mobile device. Using the mobile device, she validates the data values submitted by the clinician. Once the data values are validated, potential attack vectors and associated vulnerabilities for the heart rate monitor are identified. For this example, the firmware version may indicate that the heart rate monitor has a potential attack vector via the storage and memory portions of the heart rate monitor. This attack vector has an associated vulnerability of a programming language vulnerability to memory errors (e.g., buffer overflow); attack causing malfunctioning of device performance.

Based on the attack vector and associated vulnerability, a web-scraper is deployed to gather information regarding security measures to combat the attack vector and associated vulnerability. Thereafter, the security measure is implemented on the heart rate monitor (e.g., USB (universal serial bus) drive, tethered update via a mobile device, etc.), and the security profile of the heart rate monitor is updated.

Security Profiles, Risk Rating, and Confidence Rating

Various aspects of the present disclosure are directed toward security profiles. As noted herein, security profiles are comprised of parameters of varying types (e.g., product level, asset level, etc.) that can be used to qualitatively and quantitively assess an associated device.

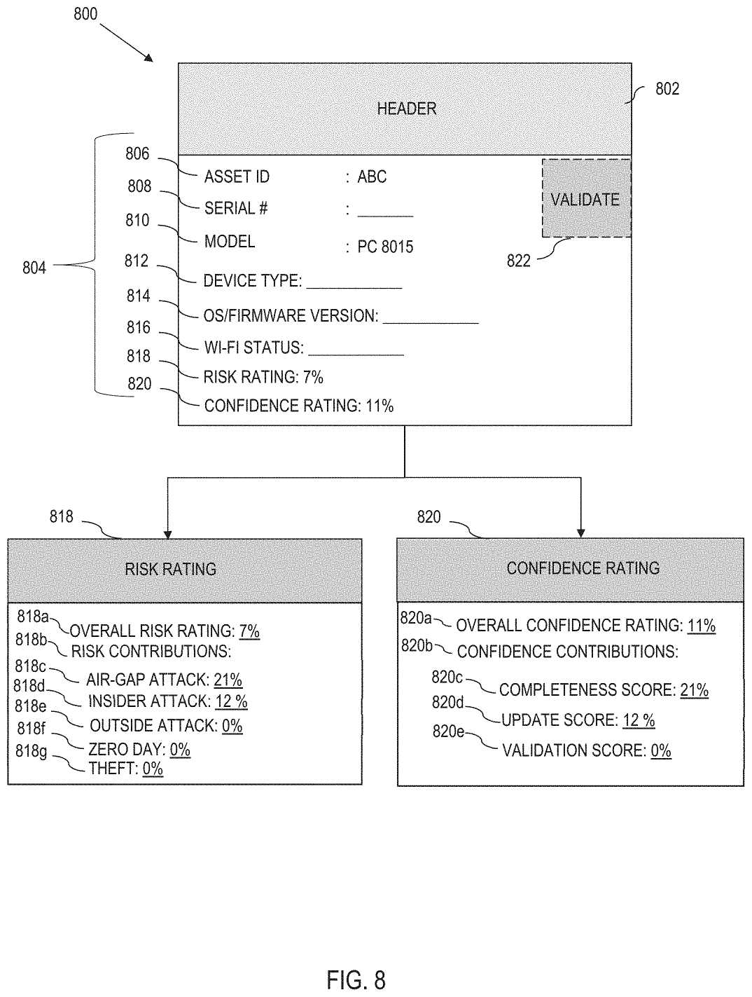

FIG. 8 illustrated an example security profile 800. In this example, the security profile has a header 802 for descriptive purposes. The security profile 800 comprises parameters 804 such as asset ID (identification) 806, serial number 808, model number 810, device type 812, OS/Firmware version 814, Wi-Fi status 816, risk rating 818, and confidence rating 820.

In select embodiments, the security profile 800 may also comprise a validation option 822. The validation option 822 allows specific users to access a repository of data and feedback submitted by other users for verification. For example, if a first user and a second user submit feedback/data with respect to a specific device, a specified third party (e.g., a service technician, network administrator, etc.) can utilize the validation option 822 to verify the feedback. In the context of gamification as described in greater detail herein, the specified third party's verification may influence points and scores earned by the users.

FIG. 8 also illustrates a more detailed breakdown of risk rating 818. Generally, risk rating 818 has an overall risk rating 818a that is calculated or derived from risk contributions 818b. Essentially, the risk rating 818 in FIG. 8 illustrates a view of how likely each of various associated attack vector probabilities are based upon a current state of a corresponding security profile.

Example risk contributions 818b include, but are not limited to, air-gap attack 818c, insider attack 818d, outside attack 818e, zero-day 818f, and theft 818g. In this example, the overall risk rating 818a is 7.00%, which is calculated using an average of the risk contributions 818b. However, the overall risk rating 818a may be calculated using other methodologies such as applying weight to specific vulnerabilities, etc.

FIG. 8 also illustrates a more detailed breakdown of the confidence rating 820. Similar to the risk rating 818, the confidence rating 820 has an overall confidence rating 818a, which is calculated or derived from confidence contributions 820b. Confidence contributions 820b includes, but are not limited to a completeness score 820c, an update score 820d, and a validation score 820e (e.g., a completeness score, an update score, a validation score, or a combination thereof).

Generally, the completeness score 820c looks to how many of the parameters for the security profile are complete. The fewer the number of complete parameters, the lower the completeness score 820c (and hence a low confidence score as well).

The validity score 820d looks to how many of the parameters with information are validated by one or more people or by a designated expert. More validations increase the likelihood that that parameters are filled with valid/good information, thus providing higher confidence ratings 820.

The update score 820e is generally directed to specific parameters or data fields that change over time. Even if a parameter is complete, the parameter may be out of date in a matter of hours, days, weeks, etc. (e.g., how a particular device is connected to the network). Thus, certain parameters may require constant updates to maintain a high confidence rating 820 (e.g., every 2 weeks, every 2 months, etc.).

In FIG. 8, in calculating the overall confidence rating 820a the completeness score 820c, update score 820d, and validation 820e may be weighted equally (e.g., averaged), or weighted differently based on factors such as a likelihood of vulnerabilities being exploited via attacks, potential adverse impact, or ability to gather and manage parameters over time, etc.

As noted above, various implementations of the present disclosure utilize graphical user interfaces (GUI) on processing units (e.g., smartphones). In such implementations, the processes and systems herein may include displaying, on the GUI, a security profile summary that comprises a device summary, comprising a device name, a serial number, a device type, a model number, or combinations thereof. The GUI may also display a status of the device, comprising an on/off indicator, a network connection indicator, a security summary comprising a risk rating and/or confidence rating, or a combination thereof.

Device Level Security Measure System

According to aspects of the present disclosure, a system 900 for implementing device level security is disclosed. The system 900 can be utilized for instance, to implement the platform (e.g., user platform), including one or more aspects of the process described with reference to the previous Figures.

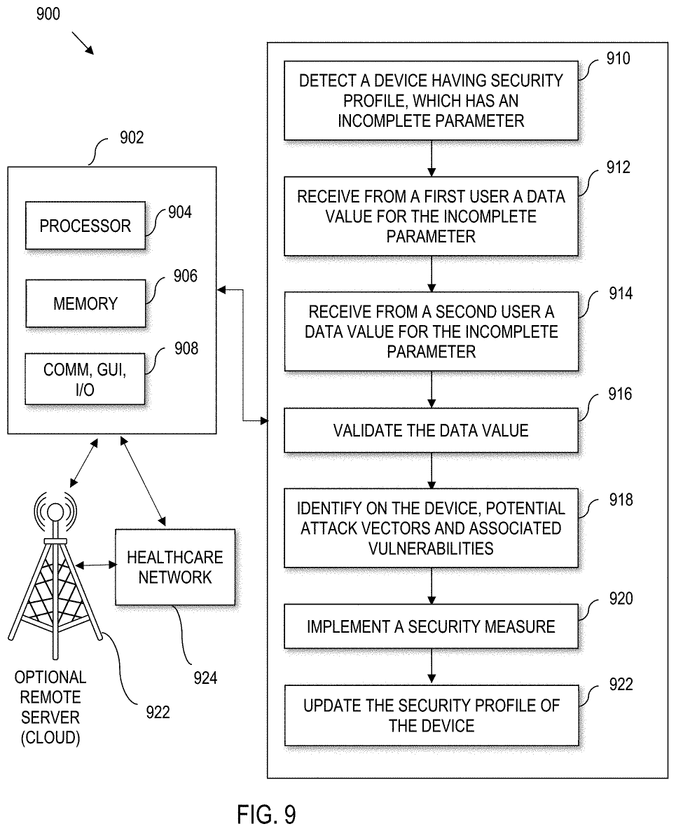

Now referring to FIG. 9, the system 900 comprises a platform 902 having a processor 904 coupled to memory 906 and a circuitry 908 (communications circuitry such as network interface, short range wireless, WiFi, cellular, combination thereof, etc., Graphical User Interface (GUI) circuitry, Input/Output (I/O) circuitry, etc.), wherein the platform 902 supports interaction with devices via the circuitry 908.

Similar to the process 300 above, aspects of the platform 902 can be executed on a mobile device such as a smartphone. In alternate embodiments, the platform 902 may be a centralized computer architecture with remote units (e.g., a mobile phone), that communicate back to the platform 902.

The processor 904 executes program code stored in the memory 906 to detect at 910 a device having a security profile, wherein the security profile has an incomplete parameter. Detection can be based on proximity or via various communication protocols on the processing device having a GUI as noted more fully herein. The security profile can comprise parameters and fields for product level information, asset level information, environmental vulnerability information, etc. as described above.

In multiple embodiments, the data value comprises make, model, device serial number, FDA class, protected health information, operating system, firmware, open ports, and external connectivity of the device.

The processor 904 is further programmed to receive at 912 feedback from a first user of the platform to supply a data value for the incomplete parameter.

The processor 904 is further programmed to receive at 914 feedback from a second user of the platform to supply a data value for the incomplete parameter.

The processor 904 is yet further programmed to validate at 916, the received feedback from the first user by comparing the received feedback from the first user with the received feedback from the second user. In various embodiments, the processor 904 is programmed reward the first user for the feedback relating to the device, and the second user for validating the feedback from the first user, via an interactive score-based user platform.

Moreover, the processor 904 is programmed to identify at 918, potential attack vectors and associated vulnerabilities of the associated device, based on the validated data value.

The processor 904 is further programmed to implement at 920 a security measure based on the identified potential attack vectors and associated vulnerabilities. In various embodiments, implementing the security measure comprises obtain a security measure that corresponds to the associated vulnerabilities (e.g., via web-scrapes, manufacturer issue patches, etc.) and installing the security measure on the device.

Further, the processor 904 is programmed to update at 922 the security profile of the device. In various embodiments, the updates can be sent to a cloud-based architecture 922, which is accessible by the platform 902 or other source (e.g., the healthcare network 924).

In various embodiments, the memory 906 is further programmed to calculate a confidence rating for the updated security profile based off of a completeness score, an update score, a validation score, or a combination thereof, as described in detail herein.

In further embodiments, the memory 906 is further programmed to calculate a risk rating for the updated security profile based off of risk contributions, wherein the risk contributions comprise vulnerabilities associated with the device as described in detail herein.

In a manner analogous to the process 300, the system 900 can incorporate reward systems to incentivize users to submit feedback and data values, as described more fully herein.

Incentive-Based Crowdsourcing (Gamification)

Data validation and integrity through the use of users, while effective, requires both time and some degree of work from the users. Thus, an incentive structure to encourage ongoing participation from the users can be an effective tool.

In multiple embodiments of the processes and systems herein, a user platform is implemented (see FIG. 1). The user platform allows designated parties to create or access user profiles, which comprise a wide variety of metrics including a user name, a user role (e.g., a profession, a particular user group, social group, etc.), a user rank/level within the user platform, a user history, and more.

For example, a healthcare facility (e.g., hospital) through the user platform can designate each employee as a user. Like users (e.g., physicians, technicians, etc.) can be grouped together. Within these groups, a hierarchy or level based structure can be implemented. For example, every user within a group may start at level one (1).

In various implementations herein, feedback is given in answer form in response to a question (or solicitation). Thus, each time a user answers a question correctly, that user is awarded “points” as a reward. For instance, as a base level of scoring, if a user correctly answers a question, the correct answer is worth three points. Subsequent answers (i.e., validations) that confirm the correct answer are worth two points, and validations that conflict with the correct answer are worth negative three (−3) points. Once a level one user gains enough points, the level one user becomes a level two user. How and when points are awarded are described in greater detail herein.

Adding a further level of depth, user level can have an impact on scoring and points. For example, a level two user still gains and loses points as described above, but has a scoring weight applied for incorrect or inconsistent answers. Whereas a level one user loses three points for an incorrect answer (e.g., bad validation), the level two user loses four points. Further, the scoring weight may be even higher for a level three user, which loses five points for an incorrect answer.

In various embodiments, the scoring weight may also apply to correct answers and validations as well, thus rewarding higher level users for their contributions and effort in achieving higher levels. In multiple embodiments, higher user levels have additional benefits. For example, higher user levels may be published or given special recognition within a user group/role, recognition across specified industries, or user level may be used to convey expertise or productivity to employers and colleagues.

Additional scoring mechanics can be utilized as well. For instance, users may be able to receive a chain bonus for answering multiple questions in a row. In one example, a user may receive a chain bonus of one point for every five questions that the user answers. The chain bonus can also be influenced by user level, such as a level three user getting three points for every five answers that the level three user answers, etc.

Yet another scoring mechanic that may be used is taking a picture of the device that the user is answering the questions about. Users may be scored for “taking the first photo”, rating an existing photo, or taking a new photo in hopes that the new photo becomes popular enough to supplant the first photo on a leader board, thus encouraging friendly competition and participation. Point values associated with each activity can vary.

In certain implementations, the user level may dictate which questions are selected for that particular user. For example, while the user role may indicate that a user has the expertise to answer a question, the certain questions may be reserved for higher level users. Questions reserved for high level users may be about a critical feature of the device, or if there are adverse consequences for incorrect information. For example, questions may be separated or delineated into easy, intermediate, and advanced questions.

In this regard, processes and systems herein may comprise accessing a user profile from the user platform, wherein the user profile comprises a user level, comparing known values associated with the information profile against the user level, and filtering out questions that are determined to exceed a capability of the user based on the comparison.

Further, questions can be selected based on factors such as the user history. For example, if the user tends to submit information regularly in the field of dialysis machines, questions that are selected for the user may be weighted toward dialysis machines.

Thus, based on the above, in various embodiments of the processes and systems herein, the process further comprises modifying a user metric (e.g., user score or user points) of at least one of the first user and the second user based on the comparison of the stored first answer against the stored second answer (e.g., modifying a user metric of the first user and/or the second user). In such embodiments, the process comprises retrieving a user baseline score from at least one of the first user and the second user, applying a positive score to the user baseline score of at least one of the first user and the second user if the first answer and the second answer are correct, and applying a negative score to the user baseline score of at least one of the first user and the second user if the first answer and the second answer are incorrect.

The gamification process can further use the behavioral trigger points and interactive score-based user interface to coordinate, augment and organize data captured from multiple sources (i.e. users) to maintain high confidence level of the device level security profile.

User-Based Validation of Data Accuracy

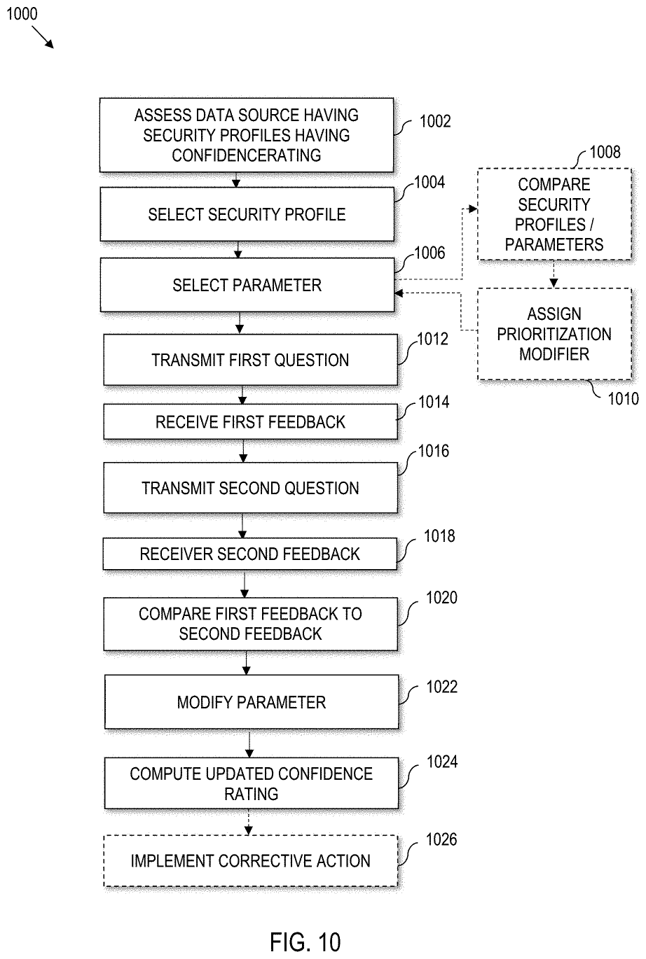

Now referring to the figures, and in particular FIG. 10, a process 1000 for user-based validation of data accuracy is disclosed. All definitions, embodiments, etc. that are applicable to the other processes and systems disclosed herein (e.g., the process 300) are also applicable to the process 1000. In this regard, not all definitions, embodiments, etc. need be used.

Generally, the process 1000 can be implemented via a user platform, which may be centralized in a designated location(s) (e.g., a local network such as 106 in FIG. 1) or implemented remotely (e.g., on a server such as 112 in FIG. 1).

The user platform allows designated parties (e.g., a network administrator) to create or access user profiles, which comprise a wide variety of fields including a user name, a user role (e.g., a profession, a particular user group, etc.), a user rank or user level within the user platform, a user history, etc.

Further, user platforms as noted herein may be divided or delineated at a company level (e.g., company A vs. company B), department level (e.g., engineering vs. sales, technicians vs. clinicians, etc.), sub-department level (chemical engineers vs. electrical engineers), or personal level (civilian, military, etc.).

The process 1000 comprises assessing at 1002 a data source, the data source having a collection of security profiles, each security profile having a confidence rating assigned thereto, wherein confidence rating characterizes a confidence in at least one of the completeness and accuracy of the data stored in the security profile (e.g., completeness of the data stored in the security profile and/or accuracy of the data stored in the security profile). Confidence and confidence ratings are described in greater detail herein.

Further, the process 1000 comprises selecting at 1004 a security profile. In various embodiments, the security profile can be selected externally. For example, in various embodiments, the process 1000 comprises selecting the security profile based on a received input from a user. For example, the user may wirelessly communicate with a device using a mobile device (e.g., Bluetooth®, owned by Bluetooth SIG, located at 5209 Lake Washington Blvd NE Suite 350 Kirkland, Wash. 98033 USA). The user can then transmit the device (including its associated security profile and parameters) to aspects of the process 1000.

The process 1000 also comprises selecting at 1006 a parameter from the security profile based upon the confidence rating of the selected security profile.

With respect to selecting 1006 the parameter, various embodiments of the process 1000 comprise prioritizing at 1006 a security profile (including the associated parameter), wherein prioritizing a security profile comprises comparing at 1008 parameters of at least two security profiles within the collection of security profiles and assigning at 1010 a prioritization modifier to one of the compared security profiles based on the calculated confidence rating, a completeness of the security profile, a need-based modifier, or a combination thereof as described herein.

Moreover, the process 1000 comprises transmitting at 1012 to a first processing unit operated by a first user, a first question for feedback, where the first question is generated based upon the selected parameter. Difficulty of question can range from low, to intermediate, to advanced. In various embodiments, user role can also be a factor to determine which questions (including how difficult the questions are) are selected.

For example, a user having the user role of a receptionist is not likely to know what the media access control (MAC) address on a particular device is. Thus, questions relating to MAC addresses are less likely to be selected for the receptionist. In this regard, a network administrator is likely to know the MAC address, thus questions relating to MAC addresses are more likely to be selected for the network administrator.

Examples of questions are:

What is the serial number of the device?

Is the device currently connected to a network?

Are there exposed USB ports?

Is this device a class 1, class 2, or class 3 device?

In various embodiments, educational or reference material can be displayed with the question. For example, for the question “Is this device a class 1, class 2, or class 3 device?”, a summary of classes 1-3 may be available for educational or reference purposes on a following page or tab.

Further, the process 1000 comprises receiving at 1014 a first feedback (i.e., answer) from the first processing unit operated by the first user, which is described in greater detail herein.

Yet further, the process 1000 comprises transmitting at 1016 to a second processing unit operated by a second user, a second question for feedback, where the second question is generated based upon the selected parameter.

In addition, the process 1000 comprises receiving at 1018 a second feedback from the second processing unit operated by the second user.

Moreover, the process 1000 comprises comparing at 1020 the first feedback to the second feedback. In various embodiments, the process 1000 transmits questions to more than two users for a higher degree of confidence, as well as enabling the process to use more complex comparison techniques.

In multiple embodiments, the feedback(s) are compared to find a common or consistent feedback (which indicates that the feedback is accurate or correct). Feedback can be compared using various mechanisms such as averages, simple majority, weighted based on the user that submitted feedback, or a combination thereof.

When using averages, for example, if 70% is a threshold value that determines which answers(s)(i.e., feedback(s)) is “correct”, the process 1000 may continue to store answers until 70% of the answers are consistent (e.g., two out of two users agree, three out of four users agree, seven out of ten users agree, etc.). In this regard, the process 1000 may have a minimum number of answers that must be stored before a comparison to determine average (e.g., minimum of ten stored answers).

Alternatively, in a simple majority, the process 1000 may continue to store answers until a majority of the answers are consistent (e.g., two out of three users agree, three out of four users agree, six out of ten users agree, etc.). In this regard, the process 1000 may have a minimum number of answers that must be stored before a comparison to determine majority (e.g., minimum of ten stored answers).

Moreover, in various embodiments a majority threshold may be used, but answers may be given a greater or lesser weight depending on the user that submitted the answer. For example, answers high level users (as described in further detail herein) may be given a larger weight than lower level users.

Still referring to FIG. 10, the process 1000 comprises modifying at 1022 the selected parameter of the selected security profile, where there is agreement between the first feedback and the second feedback, with a parameter derived from the first feedback and the second feedback. Once feedback has been determined to be correct, the parameter is updated. If the parameter was blank, the answer will fill in the blank. If the parameter had a pre-existing value, the pre-existing value is replaced.

In addition, the process 1000 comprises computing at 1024 an updated confidence rating based upon the first feedback and the second feedback.

In various embodiments, the process 1000 may comprise implementing at 1026 a corrective action when the first feedback and the second feedback do not agree. Corrective actions can include, but are not limited to issuing an alert to a pre-determined third party, quarantining the security profile, re-ask questions, etc.

Example User Experience

The following is an example of a user experience during various processes (e.g., the process 300) herein as a process. Further, while the following example user experience is directed toward interactions with a device for simplicity and clarity purposes, the processes and implementations are not limited as such, and may be used in broader applications (e.g., big data).

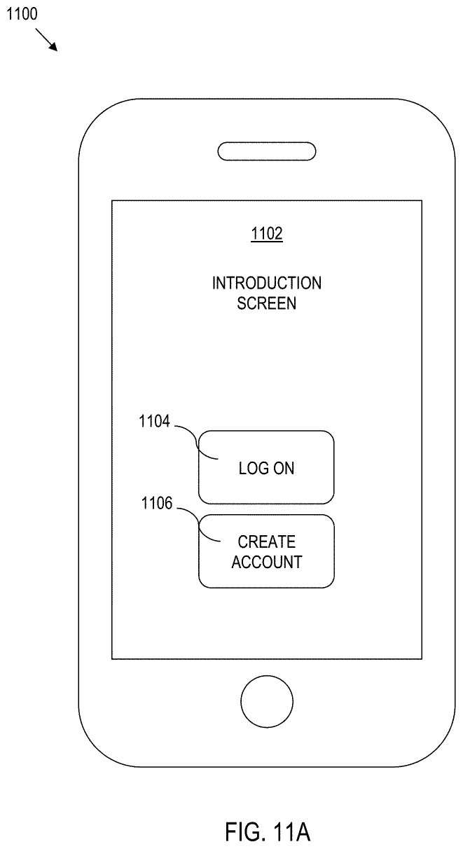

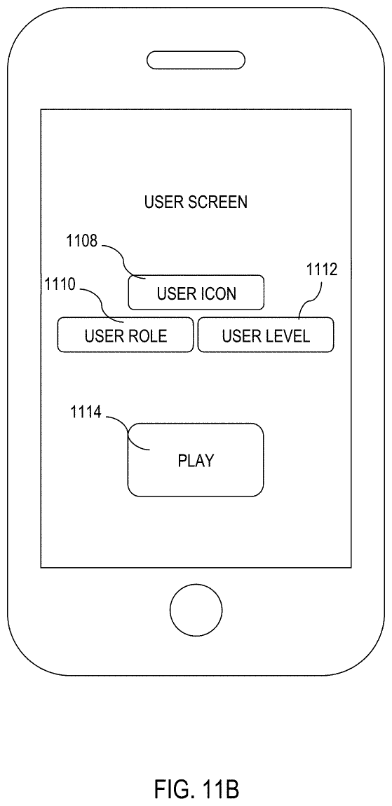

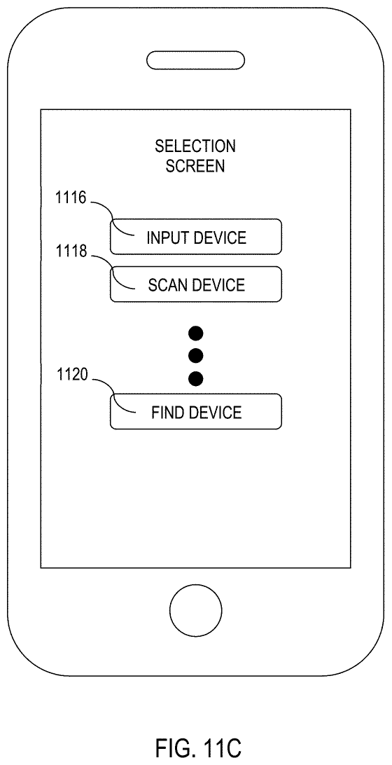

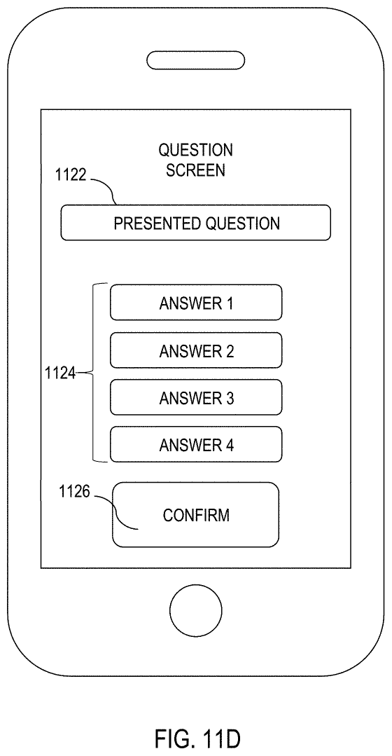

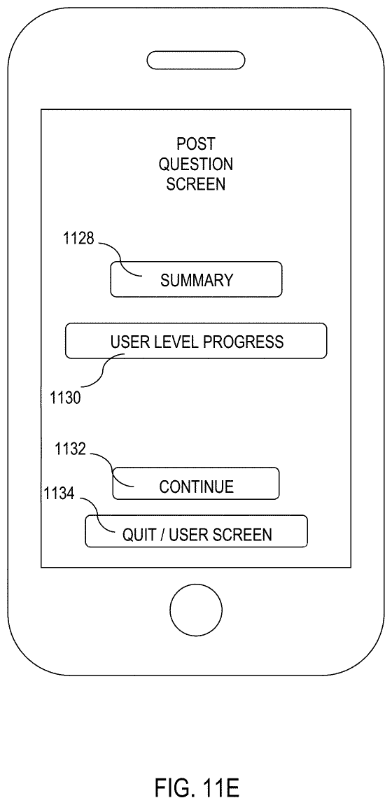

Referring to the figures, and in particular FIG. 11A, illustrates a mobile device 1100 (see processing unit, reference number 102 in FIG. 1) having a display 1102 that is displaying an introduction screen. In this example, the introduction screen has a selection for logging on 1104 to the user platform for users that have an existing user profile. Users without an existing user profile can use a selection for creating an account 1106 on to the user platform. These selections are by way of example and by no means are limiting.

In FIG. 11B, once the user has logged on, a user screen displays a user icon 1108 (e.g., a picture of the user, an avatar of the user, or any custom image or text that a user may want to use), a user role 1110, and a user level 1112. The user, when ready to proceed, can select play 1114 to participate in the game.

In FIG. 11C, a selection screen presents multiple options that the user may select from to find, or interact with a device. Users can select an input device 1116 option where the user can manually enter a device, which includes information profiles and associated data fields, into the user platform.

For example, a user might walk by a device and decide manually enter an asset ID or serial number of the device into the user platform. Further, the user may select a scan 1118 option and interact with a device. Examples include scanning a barcode on the device, taking a picture of the device and using image recognition, using Bluetooth (or other wireless protocols), etcetera. Users may also select find device 1120, which can populate a list of devices based on a variety of filters or metrics (e.g., top 110 devices with a low confidence rating, a lost device, etc.).

In FIG. 11D, a question screen presents a question 1122 along with potential answers. In this example, four answers 1124 are available. While four answers are shown in this example, there may be more or fewer than four answers. Further, questions may be in other formats such as true/false, multiple selection, fill-in, etc.

Once the user has selected an answer, the user selects confirm 1126 to submit the answer. In various embodiments, multiple questions or sets of questions may be presented as described in greater detail herein.

FIG. 11E illustrates a post question screen that displays a summary 1128. The summary 1128 can include, but is not limited to a number of questions asked, number of questions answered, calculation of points earned, comparative statistics that compare the user to other users that have answered similar questions, etc. In various embodiments, a user level progress indicator 1130 is displayed. The post question screen may also have a selection to continue answering questions 1132, a selection to quit 1134 (or go to back to the user screen), or both.

Feedback (Answers), Validation, and User Scores

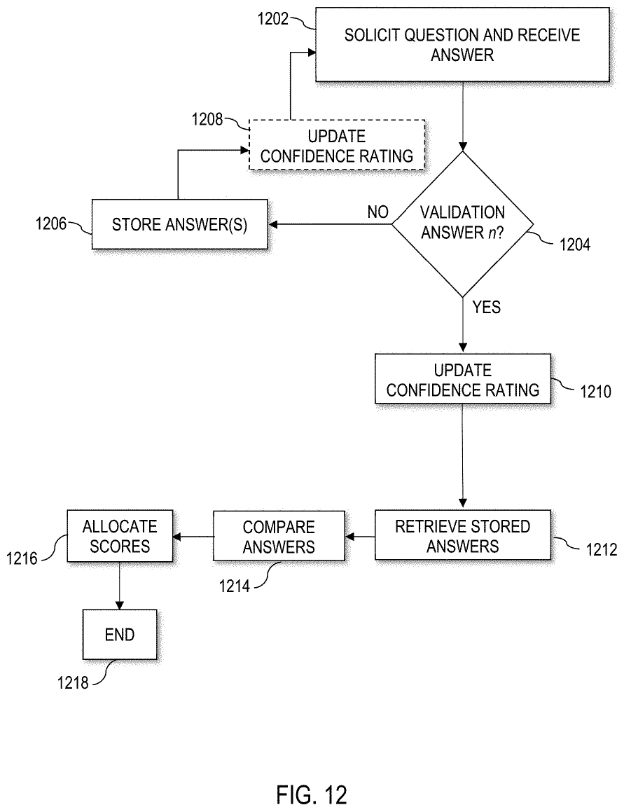

FIG. 12 illustrates a flow chart 1200 for comparing answers (i.e., feedback from users) and scoring. A first user is presented a question, and the question is answered at 1202. At 1204 is a validation check threshold that requires a predetermined number of answers (validations). If the validation check threshold at 1204 is not met, then at 1206 the first user's answer is stored and the flow chart 1200 resets to 1202. Optionally, a confidence rating of the data field from which the question is derived may be updated as shown at 1208.

Once the validation check threshold at 1204 is met, the confidence rating of the data field from which the question is updated at 1210, and the stored answers at 1206 are retrieved at 1212. The retrieved answers are compared at 1214 to determine which answer(s) is correct (e.g., based on averages, simple majority, threshold, etc.). Once the determination is made, scores are allocated at 1216 to each user (i.e., positive scores for users that answered correctly, negative scores for users that answered incorrectly), and the flow chart ends at 1218.

Miscellaneous

Aspects of the present disclosure may be embodied as a system, process or computer program product. Accordingly, aspects of the present disclosure may take the form of an entirely hardware embodiment, an entirely software embodiment (including firmware, resident software, micro-code, etc.) or an embodiment combining software and hardware aspects. Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, a portable computer diskette, a hard disk, a random access memory (RAM), a read-only memory (ROM), an erasable programmable read-only memory (EPROM), Flash memory, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device (e.g., a processor as illustrated in FIG. 8). A computer storage medium is not a transient propagating signal, as such.

A computer readable signal medium may include a propagated data signal with computer readable program code embodied therein, for example, in baseband or as part of a carrier wave. A computer readable signal medium is not a computer readable storage medium.

Computer program code for carrying out operations for aspects of the present disclosure may be written in any combination of one or more programming languages. The program code may execute entirely on the user's computer, partly on the user's computer, as a stand-alone software package, partly on the user's computer and partly on a remote computer or entirely on the remote computer or server.

Aspects of the present disclosure are described herein with reference to flowchart illustrations and/or block diagrams of process, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, process and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A process for implementing device level security, the process comprising:
detecting a device having security profile, wherein the security profile has an incomplete parameter;
receiving feedback from a first user to supply a data value for the incomplete parameter;
receiving feedback from a second user to supply a data value for the incomplete parameter;
validating the received feedback from the first user by comparing the received feedback from the first user with the received feedback from the second user;
identifying on the device, potential attack vectors and/or associated vulnerabilities, based on the validated data value;
implementing a security measure based on the identified potential attack vectors and associated vulnerabilities; and
updating the security profile of the device.

2. The process of claim 1 further comprising:
rewarding the first user and/or the second user for received feedback relating to the device, via an interactive score-based user platform.

3. The process of claim 1 further comprising:
calculating a confidence rating for the updated security profile based off of a completeness score, an update score, a validation score, or a combination thereof.

4. The process of claim 1 further comprising:
calculating a risk rating for the updated security profile based off of risk contributions, wherein the risk contributions comprises vulnerabilities associated with the device.

5. The process of claim 1, wherein receiving feedback from a first user to supply a data value comprises supplying a data value, wherein the supplied data value comprises a make, model, device serial number, FDA (food and drug administration) class, protected health information, operating system, firmware, open ports, external connectivity of the device, or a combination thereof.

6. The process of claim 1, wherein detecting a device having security profile comprises discriminating between product level information and/or asset level information.

7. The process of claim 1, wherein implementing a security measure comprises:
obtaining a security measure that corresponds to the associated vulnerabilities; and
installing the security measure on the device;
wherein obtaining a security measure that corresponds to the associated vulnerabilities comprises web-scraping a data source.

8. The process of claim 1, wherein detecting a device having security profile comprises detecting the device using a communication protocol on a processing device, wherein the processing device has a graphical user interface.

9. The process of claim 8 further comprising:
displaying, on the graphic user interface, a security profile summary that comprises:
a device summary, comprising a device name, a serial number, a device type, a model number, or a combination thereof;
a status of the device, comprising an on/off indicator, a network connection indicator, or a combination thereof;
a security summary, comprising a risk rating and/or confidence rating; or
a combination thereof.

10. The process of claim 1 further comprising:
outputting on a graphical user interface, a view of how likely each of various associated attack vector probabilities are based upon a current state of a corresponding security profile.

11. A system for implementing device level security, the system comprising:
a processor in the platform comprises a controller coupled to memory that executes program code stored in the memory to:
detect a device having a security profile, wherein the security profile has an incomplete parameter;
receive feedback from a first user of the platform to supply a data value for the incomplete parameter;
receive feedback from a second user of the platform to supply a data value for the incomplete parameter
validate, the received feedback from the first user by comparing the received feedback from the first user with the received feedback from the second user;
identify on the device, potential attack vectors and/or associated vulnerabilities, based on the validated data value;
implement a security measure based on the identified potential attack vectors and associated vulnerabilities; and
update the security profile of the device.

12. The system of claim 11, wherein the controller coupled the memory is further programmed to:
reward the first user and/or the second user for received feedback relating to the device, via an interactive score-based user platform.

13. The system of claim 11, wherein the controller coupled the memory is further programmed to: calculate a confidence rating for the updated security profile based off of a completeness score, an update score, a validation score, or a combination thereof.

14. The system of claim 1, wherein the controller coupled the memory is further programmed to calculate a risk rating for the updated security profile based off of risk contributions, wherein the risk contributions comprises vulnerabilities associated with the device.

15. The system of claim 11, wherein the controller coupled the memory is further programmed to implement a security measure based on the identified potential attack vectors and associated vulnerabilities by:
obtaining a security measure that corresponds to the associated vulnerabilities; and
installing the security measure on the device.

16. The system of claim 15, wherein the controller coupled the memory is further programmed to obtain a security measure that corresponds to the associated vulnerabilities comprises code for web-scraping a data source.

17. The system of claim 11, wherein the controller coupled the memory is further programmed to detect a device having security profile comprises detecting the device using a communication protocol on a processing device, wherein the processing device has a graphical user interface.

18. A process for user-based validation of data accuracy, the process comprising:
accessing a data source, the data source having a collection of security profiles, each security profile having a confidence rating assigned thereto, wherein the confidence rating characterizes a confidence completeness of the data stored in the security profile and/or accuracy of the data stored in the security profile;
selecting a security profile from the collection of security profiles;
selecting a parameter within the security profile based upon the confidence rating of the selected security profile;
transmitting to a first processing unit operated by a first user, a first question for feedback, where the first question is generated based upon the selected parameter;
receiving a first feedback from the first processing unit operated by the first user;
transmitting to a second processing unit operated by a second user, a second question for feedback, where the second question is generated based upon the selected parameter;
receiving a second feedback from the second processing unit operated by the second user;
comparing the first feedback to the second feedback;
modifying the selected parameter, where there is agreement between the first feedback and the second feedback, with a parameter derived from the first feedback and the second feedback; and
computing an updated confidence rating based upon the first feedback and the second feedback.

19. The process of claim 18 further comprising:
implementing a correction action when the first feedback and the second feedback do not agree.

20. The process of claim 18 further comprising prioritizing a security profile, wherein prioritizing a security profile comprises:
comparing parameters of two security profiles within the collection of security profiles; and
assigning a prioritization modifier to one of the compared security profiles based on the calculated confidence rating, a completeness of the security profile instance, a need-based modifier, or a combination thereof.
